(19) United States
(12) Patent Application Publication
(10) Pub. No.: US 2013/0150235 A1
(43) Pub. Date: Jun. 13, 2013

(54) METHOD FOR MANUFACTURING CORE-SHELL TYPE SUPPORTED CATALYSTS AND CORE-SHELL TYPE SUPPORTED CATALYSTS FORMED THEREBY

(71) Applicant: Bum Wook Roh, Seongnam (KR)

(72) Inventor: Bum Wook Roh, Seongnam (KR)

(73) Assignees: KIA MOTORS CORPORATION, Seoul (KR); HYUNDAI MOTOR COMPANY, Seoul (KR)

(21) Appl. No.: 13/531,818

(22) Filed: Jun. 25, 2012

(30) Foreign Application Priority Data
Dec. 12, 2011 (KR) 10-2011-0132546

(51) Int. Cl. B01J 21/18; B01J 23/755; B01J 23/745; B01J 23/44; B01J 23/42; B01J 23/75; B82Y 40/00

(52) U.S. Cl. 502/185; 502/182; 977/847; 977/896

(57) ABSTRACT

A method for manufacturing a core-shell type supported catalyst, wherein alloy particles having a core-shell structure with a different interior and exterior are supported on a complex carbon support. The method includes: 1) dissolving and dispersing a carbon support in a solvent using a stabilizer; 2) dissolving a core precursor in the solution, and adding a strong reducing agent to reduce and support a transition metal of the core precursor on a surface of the carbon support; 3) filtering and washing the carbon support on which the transition metal is supported; 4) re-dispersing the filtered and washed carbon support in a shell precursor aqueous solution; and 5) adding a weak reducing agent to the solution of step 4) at 60˜80° C. so that metal ions of a shell precursor are selectively reduced and deposited on the transition metal.

### CROSS-REFERENCE TO RELATED APPLICATION

This application claims under 35 U.S.C. §119(a) the benefit of Korean Patent Application No. 10-2011-0132546 filed on Dec. 12, 2011, the entire contents of which are incorporated herein by reference.

### BACKGROUND

(a) Technical Field

The present invention relates to a method for manufacturing a core-shell type supported catalyst. More particularly, the present invention relates to a method for manufacturing a core-shell type supported catalyst, in which alloy particles having a core-shell structure with a different interior and exterior are supported on a complex carbon support.

(b) Background Art

Fuel cells are devices which convert a chemical energy of fuel (such as hydrogen) to an electric energy. Such a fuel cell has a theoretical efficiency of up to 100%, and generally has a high efficiency of 80˜50%. Thus, much research has been conducted on the efficient use of fuel cells and on the use of hydrogen as a recyclable energy source, particularly in light of limited available fossil fuel resources.

The generation of electrical energy by a fuel cell is basically based on an electrochemical reaction accompanied by migration of electrons. It is important to induce a reaction in which overvoltage can be minimized in such a manner that the polarization can be minimized at the equilibrium potential at the same electrochemical reaction speed.

To accomplish this, the catalyst particles must have an improved degree of dispersion and a shape suitable for participating in the reaction.

In order to improve the surface reaction rate of catalyst particles to enhance the reaction rate of the catalyst particles in a fuel cell, much research on has been directed towards the development of platinum alloy catalyst particles with a core-shell structure, and methods for optimizing an electrode shape by controlling electrode porosity, catalyst particle miniaturization, and effective reaction area.

A solid electrolyte membrane fuel cell (Polymer Electrolyte Membrane Fuel Cell: PEM FC) using hydrogen as a fuel includes a Membrane Electrode Assembly (MEA), a Gas Diffusion Layer (GDL), etc. The MEA includes a polymer electrolyte membrane disposed between catalytic electrodes. Electrochemical reactions taking place in the electrodes generate ions, which are exchanged through the polymer electrolyte membrane. The GDL performs a role of uniformly distributing reactive gases, and transferring a generated electric energy. In the membrane electrode assembly, the polymer electrolyte membrane further has, on the both sides thereof, electrodes applied with a catalyst for allowing hydrogen (fuel) and oxygen (oxidizing agent) to be reacted. In other words, the polymer electrolyte membrane has an oxygen electrode (cathode) at which oxygen reduction occurs and a hydrogen electrode (anode) at which hydrogen oxidation occurs.

Accordingly, since the MEA provides a place where an electrochemical reaction occurs which allows electrons to be used, the MEA is important in the performance of a fuel cell.

An anode (one of the electrodes) is supplied with hydrogen, and the hydrogen's protons and electrons are decomposed by an electrochemical reaction, and are transferred to a cathode at the opposite side through respective different pathways. Then, the protons and the electrons react with oxygen at the cathode, thereby producing water.

In order to enhance the performance of a fuel cell, it is urgently required to improve the smooth transfer of oxygen to a reaction site (i.e., cathode), and to increase the reaction rate at the reaction site. To achieve this, it is known to date that the single best element as a cathode catalyst material is platinum.

However, due to the limited resources of platinum, especially due to the increasing tendency to use such resources in weaponry, the price of platinum has continuously soared. In an attempt to reduce the usage amount of platinum, many researchers have tried to secure a wide reaction area by miniaturizing platinum particles. However, it has been found that the success of this approach is severely limited.

In attempts to overcome the limitation, much research has been carried out on the alloying of platinum, based on the understanding of an oxygen reduction reaction mechanism. There have been reported many cases where the activity of a catalyst was greatly improved by addition of elements such as Co, Ni, Au, etc. to platinum which forms a solid solution state of platinum. However, to date, there has been no report of improvements in an actual MEA state.

Meanwhile, in the alloying process, rather than forming a uniform solid solution, research has been conducted on forming a non-uniform nano catalyst in which the interior and exterior have different elements. In particular, much research has been conducted on development of a core-shell type catalyst in which the interior of a nano catalyst particle is filled with a metal (Pd, Co, Ni, Fe, Mn) cheaper than platinum, and the exterior is covered with platinum.

Such an alloying process changes the atomic structure of the catalyst, thereby changing the electronic structure. In other words, atoms of platinum change the structure of a valence d-band, thereby reducing the adsorption energy between platinum and oxygen. It has been reported that, as a result, the adsorption of platinum atoms existing on the nano catalyst particle surface is reduced, with OH ions generated by decomposition of water, thereby increasing the activity of an oxygen reduction reaction (V. R. Stamenkovic, et. al., Science, vol. 315, p. 493).

In other words, it is possible to significantly reduce the usage amount of platinum and to maximize the activity by filling the interior of a catalyst particle with a core particle cheaper than platinum, and providing platinum as only the exterior surface layer of the catalyst particle.

As a process for supporting palladium on carbon through reduction of the palladium, a borohydride reduction process is generally used.

The borohydride reduction process may be simplified by eliminating the use of a conventional stabilizer. However, there are disadvantages to elimination of the stabilizer in that flocculation of nano particles existing on a carbon support surface can be serious, and further, nano particles may not be generated on the carbon support surface.

In addition to the borohydride reduction process, a polyol method has also been used. In this method, a dehydrogenation reaction is caused by heating an alcohol solvent, such as ethylene glycol or 1,2-propanediol, while a dissolved metal precursor is reduced.

However, such a polyol method has a disadvantage in that a nano particle with a high oxide ratio, instead of a pure metal nano particle, is produced due to the incomplete reduction of an added metal precursor, or sodium hydroxide (NaOH) as an additive. While the oxide may have only a minor effect on a platinum nano particle, it has a significant effect on the oxidation of other precious metals. As a result, it may cause a reduction in electrochemical activity.

A method of supporting a transition metal nano particle (such as nickel, palladium) on a carbon powder surface using a solvent, a precursor, a reducing agent, etc. is described in Korean Patent Registration Publication No. 10-917697, Korean Patent Registration Publication No. 10-738062, and Korean Patent Application Publication No. 10-2006-030591. However, mass production using this method is industrially difficult because a reduction process is carried out which requires a high-temperature heat treatment process.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made to solve the above-noted problems, and provides a method for manufacturing a core-shell type supported catalyst. In particular, according to the present method, a solution in which a stabilizer and a carbon support are dissolved/dispersed is mixed with a core precursor, and then the mixture is combined with a strong reducing agent for reduction in a short time. The result is a catalyst core supported on the carbon support. The catalyst core is then dispersed in a platinum precursor aqueous solution, and the platinum is selectively reduced and deposited only on the surface of the catalyst core using a weak reducing agent.

In one aspect, the present invention provides a method for manufacturing a core-shell type supported catalyst, the method including the steps of: 1) dissolving and dispersing a carbon support in a solvent using a stabilizer; 2) dissolving a core precursor in a solution obtained from step 1), and adding a strong reducing agent thereto so as to reduce and support a transition metal of the core precursor on a surface of the carbon support; 3) filtering and washing the carbon support on which the transition metal has been supported; 4) re-dispersing the filtered and washed carbon support in a shell precursor aqueous solution; and 5) adding a weak reducing agent to a solution obtained from step 4) at a suitable temperature (e.g., about 60˜80° C.) so that metal ions of a shell precursor are selectively reduced and deposited on the previously synthesized transition metal.

Herein, the shell precursor aqueous solution can be any solution in which a platinum precursor is dissolved, and the stabilizer is any suitable stabilizer and, particularly, SDS (sodium dodecyl sulfate).

According to various embodiments, the carbon support includes one or more types of complex supports selected from carbon based complex supports, particularly selected from the group including carbon black, carbon nanotube, carbon nanofiber, carbon nanocoil and carbon nanocage.

According to various embodiments, the core precursor includes a precursor of a transition metal selected from the group including palladium, cobalt, iron, and nickel, and mixtures thereof.

In another aspect, the present invention provides a core-shell type supported catalyst manufactured by such methods.

According to the inventive method for manufacturing the supported catalyst, an alloy catalyst particle having a core-shell structure with different interior/exterior elements can be synthesized while being supported on a complex carbon support.

Herein, the interior catalyst core portion constituting the catalyst particle can be substituted with a metal other than platinum, such as a metal that is cheaper than and/or more readily available than platinum. Thus, it is possible to reduce the usage amount of platinum, and to reduce costs.

Also, according to the method of the present invention, a stabilizer can be added in a reducing/supporting process of a core precursor, thereby optimizing the supporting of the catalyst core on the complex carbon support. Also, a strong reducing agent can be beneficially used so that a time required for flocculation between particles is shortened, and the flocculation is minimized. Thus, it is possible to obtain nano particles without a heat treatment process at high temperature. For example, a high temperature can generally correspond to a temperature of at least about 500-1000° C., such that the nano particles can be obtained by the present method without a heat treatment process at such high temperatures.

As described above, in the inventive method, it is possible to finely disperse nano sized particles without a conventional complicated process such as heat treatment. Also, through a simple reduction/deposition process using a weak reducing agent, a core-shell structure catalyst particle can be manufactured. Thus, it is possible to commercially mass-produce the catalyst.

Furthermore, the supported catalyst manufactured by the inventive method has a core-shell structure in which platinum is covered on the outside of a metal, particularly a transition metal. Thus, a platinum material can be used as a catalyst in a fuel cell in such a way that the usage amount of platinum can be significantly reduced. Also, due to the alloying effect between platinum and different metals which may form the interior of the catalyst, the reaction activity of the catalyst can be maximized. Accordingly, the platinum material can be usefully used as the catalyst material in the fuel cell.

Other aspects and exemplary embodiments of the invention are discussed infra.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a view showing a method for manufacturing a core-shell type supported catalyst according to an embodiment of the present invention;

FIG. 2 is a TEM image where palladium is reduced/supported on a carbon support, according to an embodiment of the present invention;

FIG. 3 is a TEM image showing a core-shell structure catalyst particle, in which platinum is selectively reduced/deposited on the palladium shown in FIG. 2, according to an embodiment of the present invention;

FIG. 4 is a view showing performance test results when an MEA of a PEM FC (Proton Exchange Membrane Fuel Cell) was manufactured using each of a catalyst synthesized in the Example of the present invention, and a conventional commercial catalyst; and

FIG. 5 is a graph showing test results obtained through a catalytic activity area of each MEA when an MEA of a Proton Exchange Membrane Fuel Cell (PEM FC) was manufactured using each of a core-shell structure catalyst particle synthesized in the Example of the present invention, and a conventional commercial catalyst.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

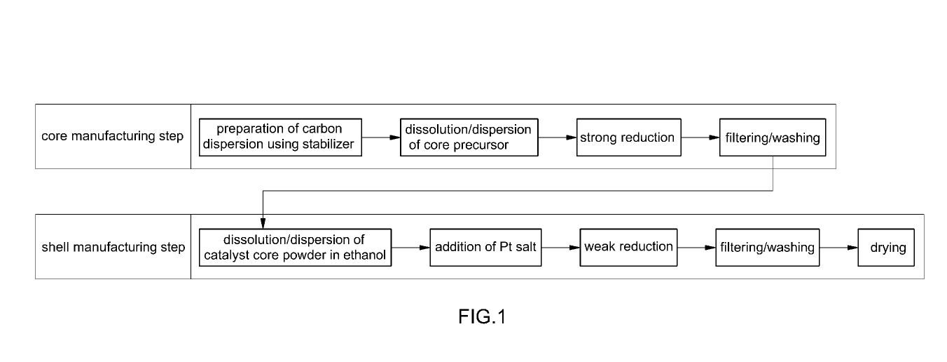

Hereinafter, the present invention will be described in detail with reference to FIG. 1.

The present invention relates to a method for manufacturing a core-shell type supported catalyst, and in particular to such a method in which a transition metal particle (such as palladium (Pd), cobalt (Co), iron (Fe), and nickel (Ni)) supported on a carbon support is used as a catalyst core, and the exterior of the core is covered with platinum. In the catalyst, a transition metal which can beneficially be relatively cheaper than platinum is uniformly and finely dispersed in and synthesized with the carbon support, and on the surface of the synthesized transition metal, platinum is layered and synthesized. In other words, the interior of a conventional catalyst particle is substituted with an element other than platinum. This reduces the usage amount of platinum, and improves the catalytic activity during an electrochemistry reaction.

As is generally known, the manufacture a platinum alloy catalyst is primarily divided into two methods. In one method, different kinds of elements are reduced while in a solid solution state. In the other method, a nano particle catalyst is formed in a complex shape, in which the interior and the exterior are phase-separated and perform different respective roles. The former method (i.e. reduction in a solid solution state) may be further divided into two methods. In one method, platinum and a transition metal are reduced together and are subjected to heat treatment. In the other method (precursor deposition method), platinum is first reduced, and then a transition metal salt is impregnated and reduced through heat treatment. In the first of these methods (where different kinds of metals are reduced together), in order to overcome the heterogeneous generation/growth caused by the difference in the reduction speed between respective elements, a strong reducing agent is required, and thus a strong reduction process is utilized. In this case, it is difficult to control the size of a metal particle, the difference between metals in the reduction speed undesirably reduces the alloying degree, and an alloy element such as a transition metal is concentrated on a catalyst surface due to a high reduction speed of a precious metal. In this case, most transition metals on the surface are molten under a fuel cell operating condition due to a low equilibrium potential, thereby reducing the performance of the fuel cell. Meanwhile, in the second of these methods (precursor deposition method), heat treatment is generally carried out. The heat treatment may cause coarsening of particles, and a difficulty in controlling a particle size.

Accordingly, the present invention provides a method for manufacturing a core-shell structure alloy catalyst, in which the interior and the exterior of a catalyst particle include different elements. In particular, according to various embodiments, the interior (catalyst core) is first filled with a relatively cheaper element, and then platinum is selectively reduced/deposited on the outer surface of the first formed interior particle,. In various embodiments, the reduction-synthesized platinum concentrically covers the first formed interior particle. For example, the reduction-synthesized platinum may be formed in a spherical or spherical-like shape over the interior particle. According to various embodiments, the interior/core material is first impregnated on a carbon material, and then platinum is deposited on the core surface, particularly wherein the platinum is spherically deposited. According to particularly preferred embodiments, the present catalyst can be provided in such a way that platinum is not formed in the interface where transition metal particle core (e.g., Pd-core) and carbon meet with each other. As such, the present catalyst and method remedies the inefficiency that is typically present in the portion where platinum in the core and carbon meet with each other. According to various embodiments, rather than covering the entire core surface with platinum, only a portion of core surface is covered, such as by providing platinum in a semi-spherical shape on the core surface.

An embodiment of the inventive method for manufacturing a supported catalyst, as shown in FIG. 1, includes: a catalyst core synthesizing step of dispersing (preferably uniformly) and supporting an element cheaper than platinum on a carbon support in a nano particle form; and a catalyst shell synthesizing step of layering a catalyst shell of platinum on the surface of the catalyst core supported on the carbon support.

More specifically, an embodiment of the inventive method of manufacturing a core-shell type supported catalyst includes the steps of:

1) dissolving and dispersing a carbon support in a solvent using a stabilizer;

2) dissolving a core precursor in the solution obtained from step 1), and adding a strong reducing agent thereto so as to reduce and support a transition metal of the core precursor on a surface of the carbon support;

3) filtering and washing the carbon support on which the transition metal (i.e. catalyst core) has been supported in step 2);

4) re-dispersing the carbon support which has been filtered and washed in the step 3), in a shell precursor aqueous solution;

5) adding a weak reducing agent to a solution obtained from step 4) at a suitable temperature (e.g., about 60˜80° C.) so that metal ions of the shell precursor can be selectively reduced and deposited on the previously synthesized transition metal (i.e. catalyst core).

According to this embodiment, sodium dodecyl sulfate (SDS) is used as the stabilizer. The carbon support includes one or more types of complex support materials, which can be selected from carbon materials, particularly the group including carbon black, carbon nanotube, carbon nanofiber, carbon nanocoil and carbon nanocage.

As the shell precursor aqueous solution, any solution in which a precursor of platinum capable of being used as a catalyst material of a fuel cell is dissolved is used. As the core precursor, a precursor of a transition metal selected from the group including palladium, cobalt, iron, and nickel is used. It is also possible to provide mixtures of one or more transition metals, if desired.

As used herein, the term “core precursor” and similar language relates to a precursor of a transition metal (such as palladium) that will form a catalyst core of a catalyst particle, and the term “shell precursor” and similar language relates to a precursor of a metal (such as platinum) that will form a catalyst shell of a catalyst particle.

In step 1), the surface of the carbon support and the stabilizer interact (preferably a stabilizer having a hydrophobic end such as SDS, such that the surface and the hydrophobic end interact) while the carbon support is uniformly dispersed in the aqueous solution. Through this method, it is possible to overcome the difficulty in dispersion of the carbon in the solvent when the surface of the carbon support is highly hydrophobic.

Also, step 1) makes it possible to use an aqueous solution (a solution containing a strong reducing agent) which can inhibit particles' flocculation occurring during the reduction of the transition metal of the core precursor in step 2).

As the carbon support, activated carbon, spherical or linear crystalline carbon, or the like may be used. The carbon support may include not only a low crystalline carbon but also a high crystalline carbon having a basal plane surface. It can be dissolved in a solution having a stabilizer dissolved in a solvent such as alcohol or water, and then finely dispersed in a nano size.

In step 2), the transition metal ions of the core precursor are reduced, preferably using a strong reducing agent, such as NaBH₄. The use of the strong reducing agent maximizes the generation speed of the transition metal particles, and inhibits particles' flocculation caused by interaction between the reduced transition metal particles and the organic solvent during the reduction of the transition metal. Thus, it is possible to form a transition metal (i.e., catalyst core) reduced and supported on the carbon support, as uniform and fine nano particles.

In step 3), after the reactions in the previous steps are completed, in order to form a catalyst shell made of platinum, the solutions, the additives, and by-products used in the previous steps are removed.

Unlike in a conventional technology, according to the present inventive method for manufacturing a supported catalyst, additives (that is, a stabilizer and a strong reducing agent) capable of being easily being removed by alcohol, etc. are preferably used to obtain fine and uniform catalyst core particles (or transition metal particles).

A conventionally used material such as oleylamine or PVP (polyvinylpyrrolidone) can be removed by only through a special treatment at a high temperature, and its removal is limited up to some extent for use in a fuel cell catalyst. On the other hand, additives that can be easily removed by alcohol, etc., can be used in the present invention to make it possible to manufacture the inventive catalyst through mass production.

In step 4), the carbon support (on which the transition metal is supported) obtained after the filtering and the washing is mixed with and dispersed in an alcohol solution containing platinum ions (that is, a shell precursor aqueous solution).

In step 5), the solution mixed/dispersed in step 4) is heated to a suitable temperature (e.g., up to about 60-80° C.), and is combined with an appropriate amount of a weak reducing agent so as to selectively reduce and deposit the catalyst shell of platinum on the transition metal catalyst core surface for about 6 hours.

The core-shell structure catalyst particles synthesized in step 5) are cooled, and then filtered and washed so as to provide catalyst particles according to the present invention.

### EXAMPLES

Hereinafter, the present invention will be described in detail with reference to the following Example, which illustrates an embodiment of the invention, but which is not intended to limit the scope of the present invention.

### Example

According to the inventive manufacturing method, a catalyst was manufactured in which palladium (Pd) and platinum (Pt) are supported on the surface of carbon in a metal weight ratio (Pd:Pt) of 5:5, 3:7, and 7:3.

Hereinafter, the manufacturing process will be described in detail.

First, 300 g de-ionized water (DI water) was mixed with 300 g acetylene black to form 600 mg of the mixture, and the mixture solution was repeatedly subjected to stirring, homogenization, and ultrasonication so as to disperse the acetylene black. Then, the resultant solution was combined with SDS (Sodium Dodecyl Sulfate), the SDS being added in an amount of 0.5 times by weight with respect to carbon. The addition of SDS uniformly disperses the carbon in the aqueous solution, and performs a role of activating the hydrophobic surface of the carbon so that it is hydrophilic. Then, a palladium nitrate (Pd(NO₃)₂) salt corresponding to palladium 200 mg was added to the solution, and stirred for 6 hours or more so as to sufficiently mix the mixture. Then, in order to reduce and support Pd dissolved in the aqueous solution on the carbon support, sodium borohydride (NaBH₄) dissolved in a solution was rapidly injected through an injector at room temperature under an air atmosphere. Herein, the stirring speed of the solution is preferably as high as possible. In this Example, the speed was controlled to a range from 600 to 800 rpm. The reducing agent was used in an amount of 4 equivalents. The reduced Pd requires a high reduction speed so as to achieve uniformity of particles, and a high degree of dispersion. Such a high reduction speed minimizes the time required for agglomerating particles through interaction between the reduced Pd and the SDS on the carbon surface, thereby inhibiting the agglomeration of the particles. After the reducing agent was added, a high stirring speed was maintained for about 30 minutes. Then, the stirring speed was appropriately lowered, and this state was maintained for at least 1 hour. Then, a washing/filtering step using ethanol was repeated three times or more so as to completely remove residual SDS. The catalyst core particle obtained after filtering was dried in a vacuum oven for about 6 hours and then collected in a powder state.

In order to form a Pt layer on Pd, the catalyst core powder obtained after complete removal of impurities was dispersed in ethanol, and PtCl₄ containing 368 mg of Pt for forming a catalyst shell was added thereto. After the addition of Platinum salt (PtCl₄), the resultant solution was sufficiently mixed by stirring for 1 hour or more, and refluxed at 70-80° C. Then, the resultant solution was combined with hydroquinone as a weak reducing agent. In a case where a reducing agent with a strong reducing power is used, platinum is reduced/supported on a carbon as well as a required Pd surface. Thus, a weak reducing agent such as hydroquinone was used. In other words, when catalyst core particles such as Pd exist in a weak reducing atmosphere, Pt is selectively reduced and doped on the surface of palladium through the catalytic action of Pd. Under such a condition, the reaction was carried out for 4 to 6 hours, and the resultant product was cooled to room temperature. Then, the resultant product was washed and filtered using ethanol, and dried in a vacuum oven at 40° C. so as to obtain core-shell structure catalyst particles.

The collected catalyst particles include a catalyst core that includes palladium supported on the surface of carbon as a support, and a catalyst shell that includes platinum reduced and deposited on the surface of the palladium.

According to this method, as carbon, tubular, platelet, and herringbone types of carbon nano fibers (CNF) may be used, and as a weak reducing agent, a weak reduction reagent as well as a weak reducing agent having OH⁻, such as acetic acid, may be used.

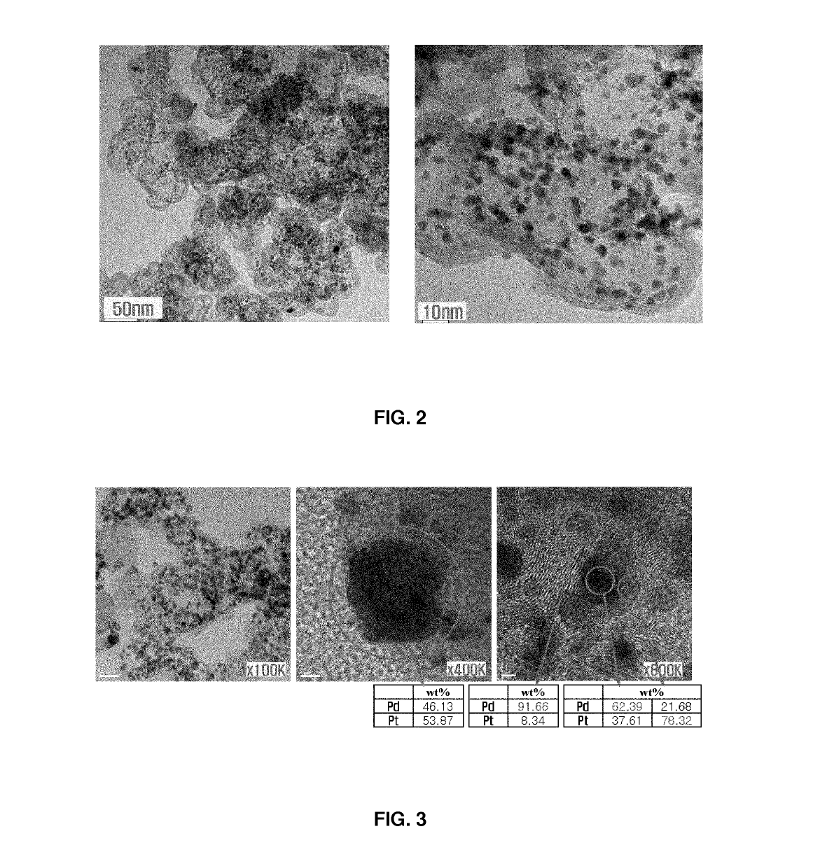

FIG. 2 is an electron microscopic image of a carbon support according to the Example, in which on the carbon support, palladium is supported. According to the results of measurements, the carbon support had Pd in a weight ratio of 25%, and the Pd had a diameter ranging from 3 to 4 nm. Also, the supported Pd particles had a uniform shape and a uniform distance therebetween.

FIG. 3 is an image showing core-shell structure catalyst particles manufactured from the Example. On the catalyst particles, the component analysis on the interior and exterior of particles was carried out through Energy Dispersive Spectroscopy (EDS). As shown in the drawing, on the interior of catalyst particles, Pd is deposited, and on the surface, Pt is concentrated. Although it was observed that some particles contain only Pt, most particles have a structure where Pt exists on the exterior, and the interior is filled with Pd.

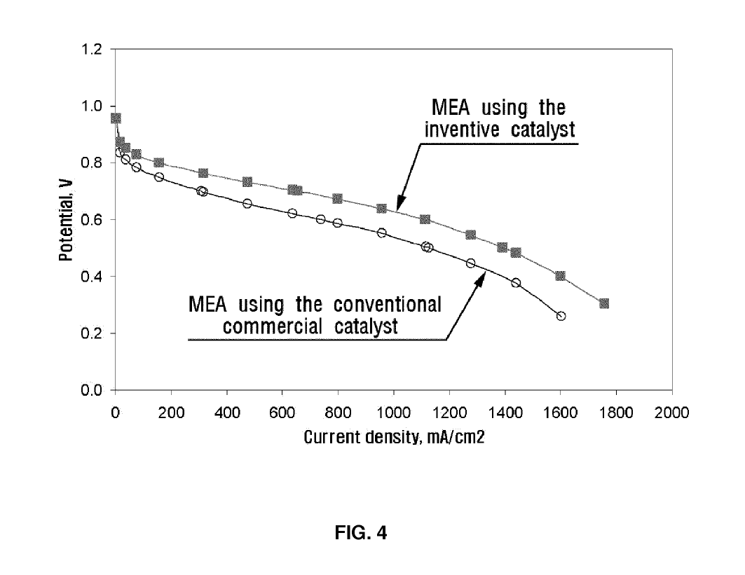

FIG. 4 is a view showing a performance test result when an MEA of a solid electrolyte membrane fuel cell was manufactured using each of a core-shell structure catalyst particle synthesized in the Example, and using a conventional commercial catalyst.

Referring to FIG. 4, it is possible to compare the performance of the MEA employing the catalyst particle [containing 0.18 mg of platinum per unit area (cm²)] from the Example in a cathode, with that of the MEA employing the conventional commercial catalyst [containing 0.25 mg of platinum per unit area (cm²)]. The results demonstrate that the MEA employing the catalyst particle from the Example has a higher performance.

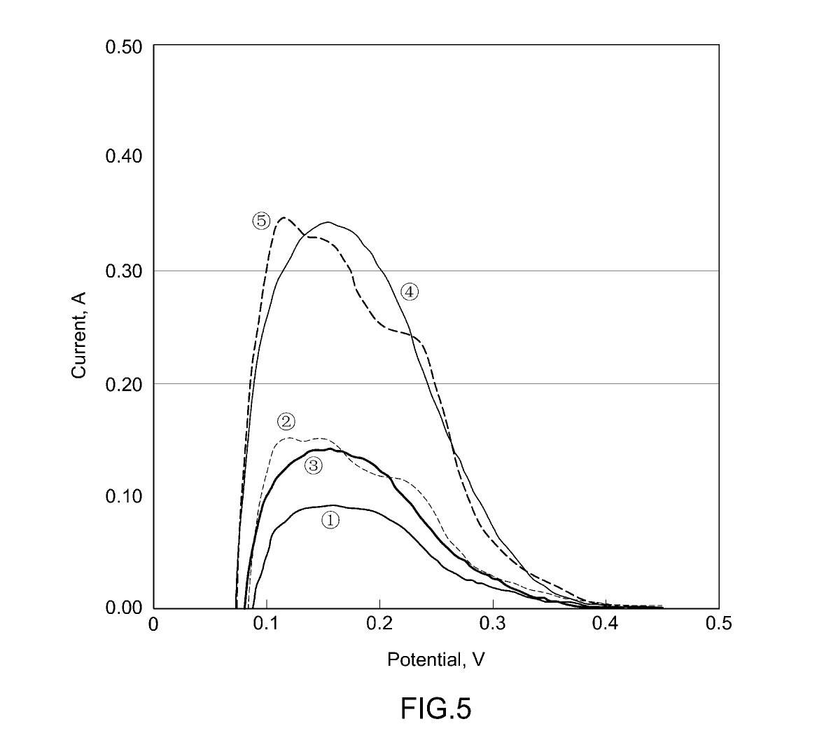

Meanwhile, FIG. 5 is a graph showing a test result obtained through a catalytic activity area of each MEA when an MEA of a PEM FC (Proton Exchange Membrane Fuel Cell) was manufactured using each of a core-shell structure catalyst particle synthesized according to the present invention, and a conventional commercial catalyst.

In FIG. 5, curve \textcircled{1} shows the test result on the catalytic activity area of an MEA manufactured by the inventive core-shell structure catalyst particle, in which a cathode includes 0.05 mg of platinum and 0.05 mg of palladium per unit area (cm²), curve \textcircled{2} shows the test result on the catalytic activity area of an MEA manufactured by the conventional commercial catalyst, in which a cathode includes 0.2 mg of platinum per unit area (cm²), curve \textcircled{3} shows the test result on the catalytic activity area of an MEA manufactured by the inventive core-shell structure catalyst particle, in which a cathode includes 0.1 mg of platinum and 0.1 mg of palladium per unit area (cm²), curve \textcircled{4} shows the test result on the catalytic activity area of an MEA manufactured by the inventive core-shell structure catalyst particle, in which a cathode includes 0.2 mg of platinum and 0.2 mg of palladium per unit area (cm²), and curve \textcircled{5} shows the test result on the catalytic activity area of an MEA manufactured by the conventional commercial catalyst, in which a cathode includes 0.4 mg of platinum per unit area (cm²).

As shown in FIG. 5, as compared to the MEA manufactured by the conventional commercial catalyst, in the MEA manufactured by the inventive catalyst particle, the usage amount of platinum was reduced to approximately half and the generated output current was similar. Accordingly, it was demonstrated that the catalytic activity area of the MEA manufactured by the inventive catalyst particle is superior to that manufactured by the conventional commercial catalyst.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a core-shell type supported catalyst, the method comprising the steps of:
1) dissolving and dispersing a carbon support in a solvent using a stabilizer;
2) dissolving a core precursor in a solution obtained from step 1), and adding a reducing agent thereto so as to reduce and support a transition metal of the core precursor on a surface of the carbon support;
3) filtering and washing the carbon support on which the transition metal has been supported;
4) re-dispersing the carbon support in a shell precursor aqueous solution; and
5) adding a weak reducing agent to a solution obtained from step 4) at about 60˜80° C. so that metal ions of a shell precursor are selectively reduced and deposited on the transition metal.

2. The method of claim 1, wherein the shell precursor aqueous solution is a solution in which a platinum precursor is dissolved.

3. The method of claim 1, wherein the carbon support comprises one or more complex support materials selected from the group consisting of: carbon black, carbon nanotube, carbon nanofiber, carbon nanocoil and carbon nanocage.

4. The method of claim 1, wherein the stabilizer is sodium dodecyl sulfate (SDS).

5. The method of claim 1, wherein the core precursor comprises a precursor of a transition metal selected from the group consisting of: palladium, cobalt, iron, and nickel.

6. A core-shell type supported catalyst manufactured by the method according to claim 1.
